(19) United States
(12) Patent Application Publication
(10) Pub. No.: US 2014/0108833 A1
(43) Pub. Date: Apr. 17, 2014

(54) POWER INFORMATION PROVIDING APPARATUS, POWER INFORMATION PROVIDING METHOD, AND COMPUTER READABLE STORAGE MEDIUM

(71) Applicant: KABUSHIKI KAISHA TOSHIBA, Tokyo (JP)

(72) Inventors: Yu Kaneko, Yokohama-shi (JP); Tomonori Maegawa, Tokyo (JP); Shigeo Matsuzawa, Tokyo (JP)

(73) Assignee: KABUSHIKI KAISHA TOSHIBA, Tokyo (JP)

(21) Appl. No.: 13/973,695

(22) Filed: Aug. 22, 2013

(30) Foreign Application Priority Data
Oct. 11, 2012 (JP) 2012-226450

(51) Int. Cl. G06F 1/32

(52) U.S. Cl. CPC G06F 1/3206
USPC 713/320

(57) ABSTRACT

A power information providing apparatus provides a content including power information. The apparatus includes an access result calculator, an energy saving result calculator, and a content type determining module. The access result calculator is configured to calculate a frequency of use of the power information providing apparatus. The energy saving result calculator is configured to calculate a value of a power consumption reduction result. The content type determining module is configured to select a type of the content based on the frequency of use calculated by the access result calculator and the value of the power consumption reduction result calculated by the energy saving result calculator.

### CROSS-REFERENCE TO RELATED APPLICATION(S)

The present disclosure claims priority to Japanese Patent Application No. 2012-226450, filed on Oct. 11, 2012, which is incorporated herein by reference in its entirety.

### FIELD

Embodiments described herein relate generally to a power information providing apparatus, a power information providing method, a computer readable storage medium.

### BACKGROUND

A BEMS (Building Energy Management System) and a HEMS (Home Energy Management System) are known as systems for reducing power consumption of a building and a house. In the following description, a system such as a BEMS and a HEMS will be referred to as an EMS (Energy Management System). Also, reduction of power consumption will be referred to as energy saving.

In general, an EMS collects power information of one or more buildings/houses over a network and stores the collected power information in a database. The EMS displays the power information stored in the database on a display of a computer or a TV receiver. In the following description, the function of displaying power information will be referred to as a “visualization function.” The visualization function of the EMS raises awareness of residents (users) of the building(s)/house(s) about energy saving and promotes their actions for energy saving (e.g., powering off unused electric equipment(s)). In the following description, an apparatus having the visualization function will be referred to as a “power information providing apparatus.” A power information providing apparatus may be either a part of an EMS or an EMS itself.

According to a related art, a power information providing apparatus provides power information for a user by the same method all the time. Examples of the method for providing the power information include “simply displaying power consumption values,” “displaying power consumption values in a form of a time-series graph,” and “flashing an LED to attract attention of a user.”

Providing power information for a user by the same method all the time may cause the user to get tired of the visualization function. If the user gets tired of the visualization function, he or she may come not to use the visualization function. As a result, its effect of promoting the user's energy saving actions is lessened, making it difficult to attain energy saving of a building(s)/house(s).

### BRIEF DESCRIPTION OF THE DRAWINGS

FIG. 1 shows an example of the system configuration according to a first embodiment;

FIG. 2 is an operation flowchart showing how a power information providing apparatus according to the first embodiment operates;

FIG. 3 shows a content type determination table according to the first embodiment;

FIG. 4 shows a content type restriction table according to the first embodiment;

FIG. 5 shows another example of the system configuration according to the first embodiment;

FIG. 6 shows an example of the system configuration according to a second embodiment;

FIG. 7 is an operation flowchart showing how sensor data is acquired and analyzed in the second embodiment;

FIG. 8 is a flowchart showing how a content is acquired in the second embodiment;

FIG. 9 shows a content type restriction table according to the second embodiment; and

FIG. 10 shows an example of the configuration of a power information providing apparatus according to the second embodiment.

### DETAILED DESCRIPTION

According to one embodiment, a power information providing apparatus provides a content including power information. The apparatus includes an access result calculator, an energy saving result calculator, and a content type determining module. The access result calculator is configured to calculate a frequency of use of the power information providing apparatus, The energy saving result calculator is configured to calculate a value of a power consumption reduction result. The content type determining module is configured to select a type of the content based on the frequency of use calculated by the access result calculator and the value of the power consumption reduction result calculated by the energy saving result calculator.

### Embodiment 1

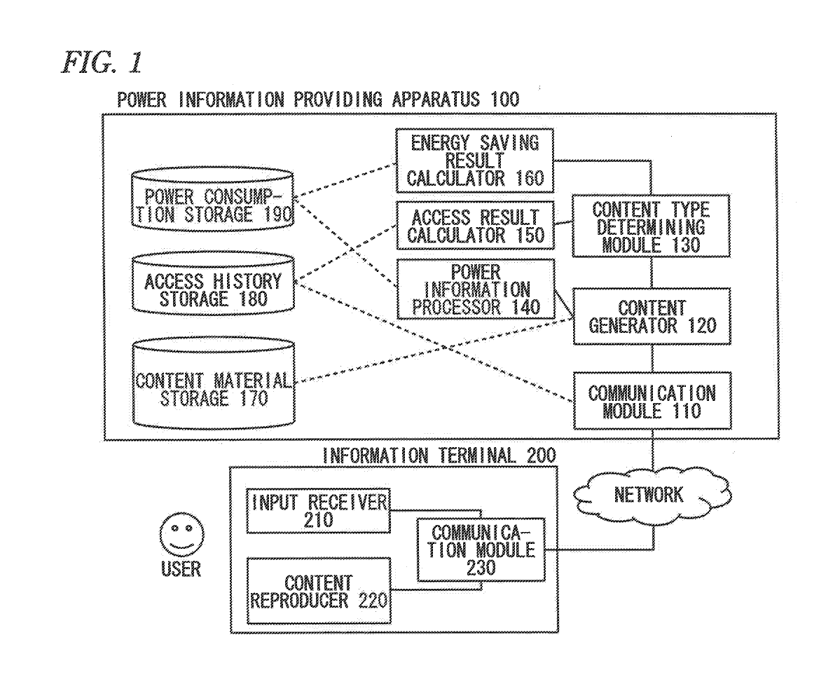

A power information providing apparatus 100 according to a first embodiment will be hereinafter described with reference to the accompanying drawings. FIG. 1 shows the system configuration assumed in the first embodiment.

The power information providing apparatus 100 according to the first embodiment selects a method for providing power information to a user based on a frequency of use of the power information providing apparatus 100 and an energy saving result of the user. The energy saving result is an index indicating what degree of energy saving the user has attained The power information providing apparatus 100 recognizes in advance what building or house the user is using.

An information terminal 200 is a terminal to be manipulated by a user and has a role of informing the user of power information. The information terminal 200 may be a personal computer, a smartphone, a cell phone, or the like. The power information providing apparatus 100 and the information terminal 200 can communicate with each other via a wired or wireless network, The network employs a communication method that complies with TCP/IP, Ethernet(R), or the like.

In the following description, information transmitted from the power information providing apparatus 100 to the information terminal 200 will be referred to as a “content.” The content is information including a text, an image, a sound, and/or the like. When the information terminal 200 reproduces a content, power information is provided to the user. For example, where the information terminal 200 is equipped with a web browser, a content including a hypertext markup language (HTML) file, a cascading style sheets (CSS) file, a Java(R) Script file, an image file, an audio file, and/or the like. Power information may be contained in an HTML file or an image file.

For example, a content is a “graph of today's power consumptions” or a “graph of power consumptions in the past one month.” Each content has a unique content ID.

The information terminal 200 includes an input receiver 210, a content reproducer 220, and a communication module 230. The input receiver 210 receives a manipulation of the user. The information terminal 200 acquires an arbitrary content by sending a content transmission request to the power information providing apparatus 100 through the communication module 230. The content transmission request has a content ID corresponding to each content. The content ID is expressed by a uniform resource locator (URL), for example. The content reproducer 220 reproduces the acquired content.

The power information providing apparatus 100 includes a communication module 110, a content generator 120, a content type determining module 130, a power information processor 140, an access result calculator 150, an energy saving result calculator 160, an access history storage 180, a power consumption storage 190, and a content material storage 170.

The communication module 110 communicates with the information terminal 200. For example, the communication module 110 sends a content to the information terminal 200 and receives a content transmission request from the information terminal 200. When receiving a content transmission request, the communication module 110 adds an access history in the access history storage 180. The access history storage 180 stores information indicating what users acquired what contents at what times. More specifically, the access history storage 180 stores sets of 1) a user ID for identification of a user, 2) a content ID, and 3) a time at which a content transmission request is received. A frequency of use of the visualization function is obtained by checking the access history.

The content generator 120 generates a content to be provided for the information terminal 200 by combining power information and a content material. The content generator 120 acquires the power information from the power information processor 140. Also, the content generator 120 acquires the content material from the content material storage 170.

The power information processor 140 processes data stored in the power consumption storage 190 to pass power information to the content generator 120. The power consumption storage 190 stores a power consumption of each of buildings/houses. More specifically, the power consumption storage 190 stores sets of 1) a building/house ID for identification of a building or a house, 2) a power consumption, and 3) a period indicating what time the power consumption corresponds to. For example, the term “processing” means calculating an integration value of power consumed for each 30 minute period or calculating an average value of power consumption for one day. What kind of processing should be performed on power consumption corresponding to what period depends on the content. For example, for a content “displaying today's power consumption hour-by-hour in a bar graph from,” the power information processor 140 performs, for the today's power consumption, processing of calculating an integration value of consumed power for each hour period. For example, data to be stored in the power consumption storage 190 may be collected from smart meters that are installed in houses over a network.

The content material storage 170 stores a content material(s) for each content ID. Examples of a content material include an HTML file, a CSS file, a Java (R) Script file, an image file, an audio file, and a program that can be run on a web browser.

Since a variety of content materials exist as described above, the content generator 120 determines a content material to be acquired based on a content type. The content generator 120 acquires the content type from the content type determining module 130.

The content type determining module 130 passes one or more content types to the content generator 120. The content type is, for example, “text,” “image,” “moving image,” “sound,” “vibration,” or the like. The content type determining module 130 determines a content type taking into consideration user's energy saving result and user's access result. The content type determining module 130 acquires the energy saving result from the energy saving result calculator 160. The content type determining module 130 acquires the access result from the access result calculator 150. Basically, if a user has not attained good energy saving result and has not accessed the power information providing apparatus 100 very often, the content type determining module 130 selects a content type(s) that would attract more attention from the user. Processing for selecting a content type will be described later.

The energy saving result calculator 160 calculates an energy saving result of a user based on data stored in the power consumption storage 190. There are various methods for calculating an energy saving result. For example, one method employs, as an energy saving result of today, a difference from a power consumption of the same day of last year. Another method employs, as an energy saving result of today, a difference from an average value of one-day power consumption over the past one month. A further another method employs, as an energy saving result of today, a difference from a predetermined target power consumption.

There is a method that rates theses calculation results in plural scales, for example, “high,” “meddle,” and “low.” Here, “high” means that an energy saving amount is large, “low” means that an energy saving amount is small, and “medium” indicates between “high” and “low.”

The access result calculator 150 calculates an access result of a user based on data stored in the access history storage 180. There are various methods for calculating access results. For example, one method employs, as an access result, a total number of accesses made in the past one week. Another method employs, as an access result, an average of numbers of accesses made in the past one week. There is a method that rates these calculation results in plural scales, for example, “high,” “medium,” and “low,” Here, “high” means a high access frequency, “low” means a low access frequency, and “medium” indicates between “high” and “low.”

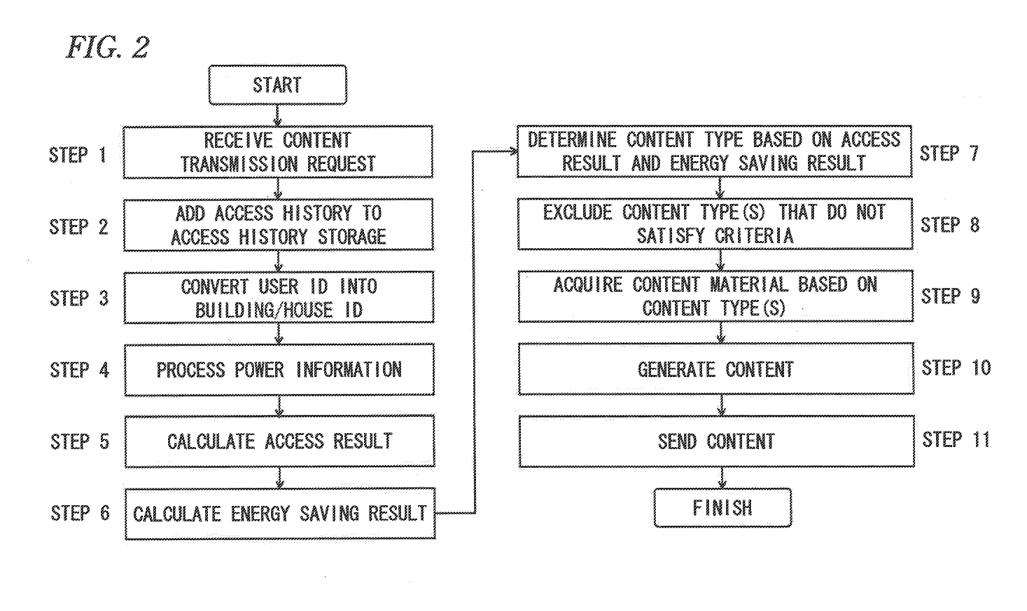

FIG. 2 is a flowchart showing how the power information providing apparatus 100 according to the first embodiment operates. Upon reception of a content transmission request from the information terminal 200, the power information providing apparatus 100 starts to operate. The information terminal 200 sends the content transmission request in response to user's manipulation. The content transmission request includes a content ID and a user ID. Also, in the flowchart of FIG. 2, it is assumed that each of the energy saving result calculator 160 and the access result calculator 150 performs evaluation on plural-point scale.

The operation flow chart is described below.

Step 1: The communication module 110 receives a content transmission request.

Step 2: The communication module 110 records a user ID, a content ID, and a current time in the access history storage 180.

Step 3: The content generator 120 derives a building/house ID from the user ID.

Step 4: The content generator 120 passes the content ID and the building/house ID to the power information processor 140 and requests the power information processor 140 to return power information to be included in a content. The power information processor 140 determines a processing method based on the content ID. For example, the power information processor 140 integrates power consumptions of today in units of 30 minutes or integrates power consumption results in the past one month in units of one day. The power information processor 140 acquires power consumptions to be processed from the power consumption storage 190 using the building/house ID and a period as conditions. The power consumption storage 190 may cache a processing result, which will increase the processing speed when the same content transmission request is received. The power information processor 140 returns the processed power information to the content generator 120.

Step 5: The content generator 120 passes the user ID and the building/house ID to the content type determining module 130 and requests the content type determining module 130 to return a content type. The content type determining module 130 passes the user ID to the access result calculator 150 and requests the access result calculator 150 to return an access result. The access result calculator 150 acquires an access history of the user from the access history storage 180. Then, the access result calculator 150 calculates an access result of the user and returns the calculated access result to the content type determining module 130.

Step 6: The content type determining module 130 passes the building/house ID to the energy saving result calculator 160 and requests the energy saving result calculator 160 to return an energy saving result. The energy saving result calculator 160 acquires, from the power consumption storage 190, using the building/house ID, power consumptions that are necessary for calculation of the energy saving result. Then, the energy saving result calculator 160 calculates the energy saving result and returns the calculated energy saving result to the content type determining module 130.

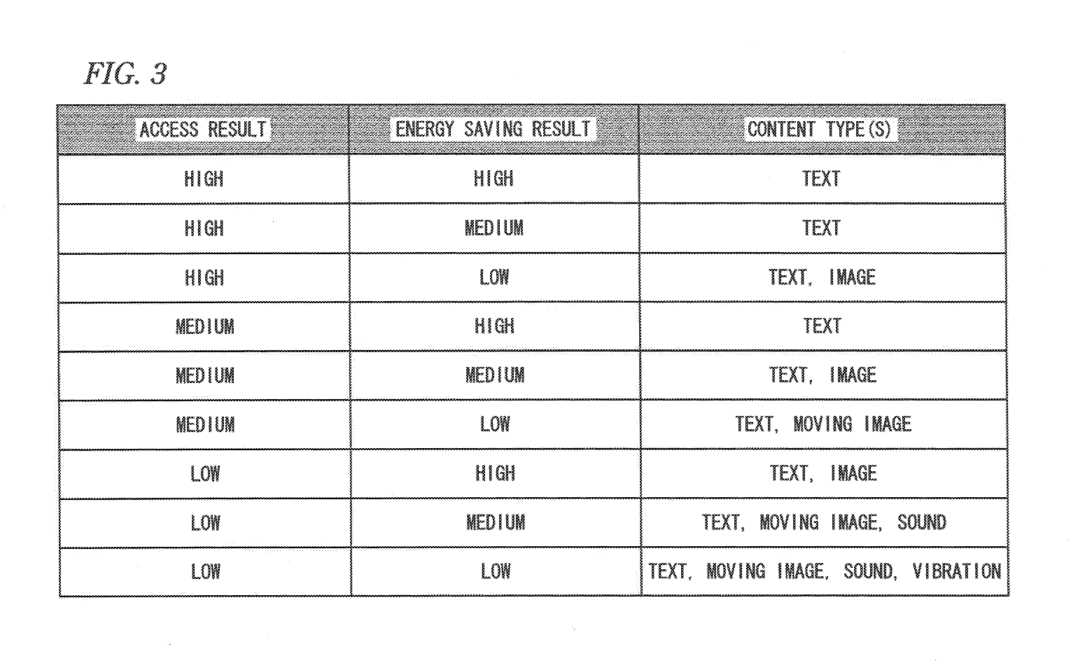

Step 7: The content type determining module 130 determines a content type based on the access result of the user and the energy saving result of the user. In the first embodiment, the content type determining module 130 has a content type determination table (see FIG. 3) that is used for determining the content type according to a combination of the access result and the energy saving result. The content type determining module 130 determines the content type using this determination table. The content type determining module 130 may return plural content types.

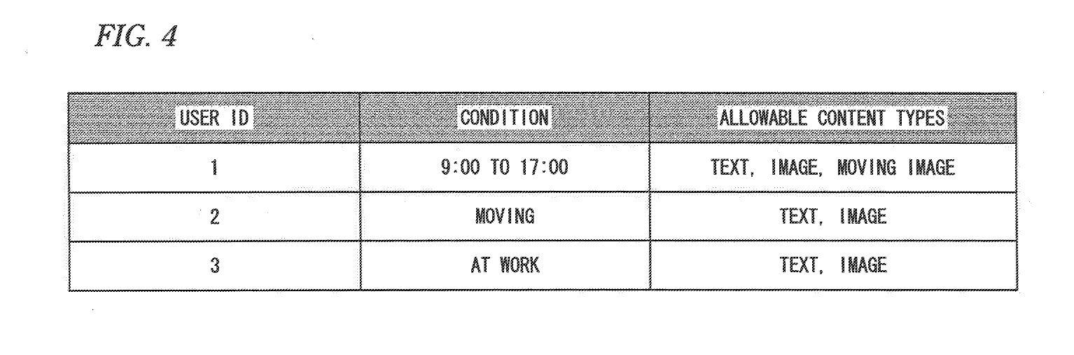

Step 8: The content type determining module 130 narrows down the content types to one(s) that can be provided for the user, taking a user situation into consideration. To narrow down the content types, the content type determining module 130 uses a content type restriction table (see FIG. 4), for example. The content type determining module 130 excludes a content type(s) that do not satisfy criteria of the restriction table from the content types determined at step 7. For example, where the user ID is “1” and the current time is 10:00, the content types “sound” and “vibration” are excluded. This prevents an event that a content whose content type is “sound” or “vibration” is transmitted to the information terminal 200 of the user while he or she is working in his or her place of work. For example, a user situation can be recognized by acquiring sensor information (e.g., GPS information), user schedule information, or the like that is held by the information terminal 200 such as a smartphone, a cell phone, or the like.

Step 9: The content generator 120 acquires a content material from the content material storage 170 based on the content ID and the content type(s). For example, if the content type is “text,” the content generator 120 acquires an HTML file and a CSS file. If the content types are “text” and “image,” the content generator 120 acquires an HTML file, a CSS file, and an image file.

Step 10: The content generator 120 generates a content based on the power information acquired from the power information processor 140 and the content material acquired from the content material storage 170. For example, the content generator 120 embeds the power information in an HTML file or an image.

Step 11: The communication module 110 sends the content generated by the content generator 120 to the information terminal 200.

Operating according to the flowchart of FIG. 2, the power information providing apparatus 100 sends a content to the information terminal 200. The information terminal 200 reproduces the received content.

The power information providing apparatus 100 may perform user authentication when receiving a content transmission request. In this case, the power information providing apparatus 100 manages passwords for the respective user IDs. A content transmission request that is sent from the information terminal 200 contains a content ID, a user ID, and a password.

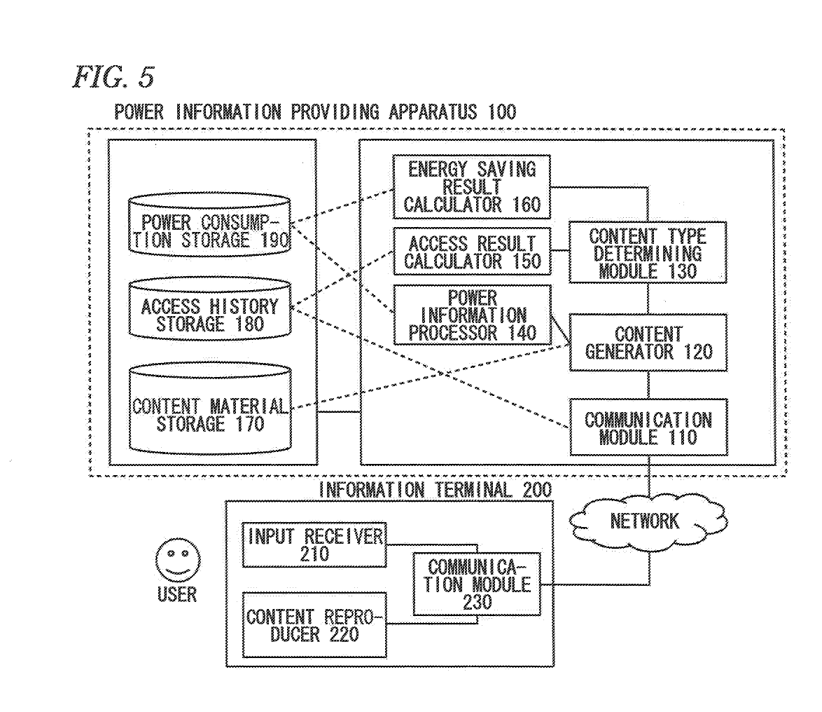

The power information providing apparatus 100 may be implemented by plural apparatus. FIG. 5 shows such a configuration. Components in FIG. 5 being the same or similar to those in FIG. 1 are given the same reference numerals, and will not be described in detail.

The power information providing apparatus (system) 100 shown in FIG. 5 includes a storage apparatus having various storages and a calculation apparatus having various calculators. The storage apparatus and the calculation apparatus are connected to each other by a network such as Ethernet(R).

The above description of the first embodiment is premised on that the information terminal 200 is provided with a web browser. However, the information terminal 200 may reproduce power information by any means other than a web browser. For example, the information terminal 200 may use, for this purpose, application (e.g., mailer) for reading of e-mails. In this case, the power information providing apparatus 100 provides power information in e-mail form.

As described above, in the power information providing apparatus 100 according to the first embodiment, a method for providing power information for a user is selected according to a frequency of use of the power information providing apparatus 100 and a user's energy saving result. This prevents the user from getting tired of the visualization function, to thereby makes it possible to maintain its energy saving effect for a long time.

For example, the power information providing apparatus 100 may be implemented by a general-purpose computer as basic hardware. That is, each of the functions of the content generator 120, the content type determining module 130, the access result calculator 150, the energy saving result calculator 160, etc. shown in FIG. 1 may be realized by causing a processor of the computer to run a program.

The power information providing apparatus 100 may be implemented either by preinstalling such programs in the computer or by delivering such programs over a network or in a state where the programs are stored in a storage medium such as a CD-ROM and installing the programs in the computer as appropriate. For example, the storages 170, 180, and 190 may be realized using, as appropriate, a memory or a hard disk drive incorporated in or attached externally to the computer or a storage medium such as a CD-R, CD-RW, a DVD-RAM, or a DVD-R.

### Embodiment 2

In a second embodiment, it is assumed that a content is always displayed on a stationary terminal which is installed in a building or a house. Examples of the stationary terminal include a TV receiver, a digital photoframe, and a monitor of a desktop personal computer. Specifically, it is assumed that a “graph of today's power consumption” is always displayed on a digital photoframe that is provided in a home and that a user checks the graph occasionally.

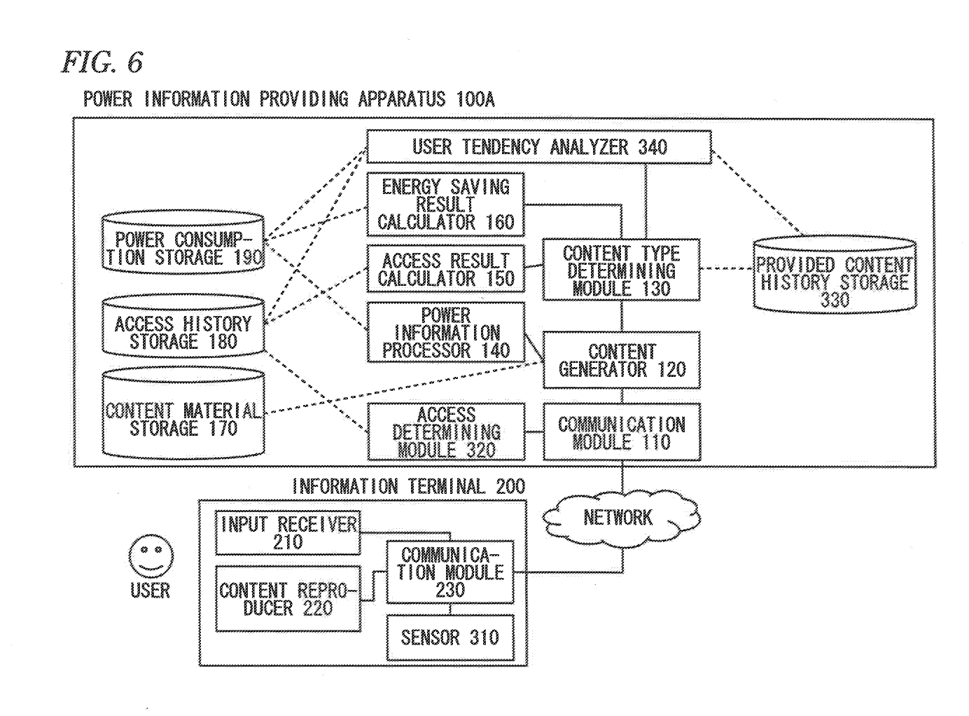

FIG. 6 shows a system configuration according to the second embodiment. Differences from the first embodiment will mainly be described below. Components in FIG. 6 being the same or similar to those in FIG. 1 are given the same reference numerals, and will not be described in detail where appropriate.

In the second embodiment, an information terminal 200A sends a content transmission request to a power information providing apparatus 100A regularly irrespective of whether or not a user is looking at the screen thereof. The information terminal 200A thus acquires a latest content and reproduces it. In this manner, the information terminal 200A always displays latest power information. As in the first embodiment, the information terminal 200A can also send a content transmission request corresponding to an arbitrary content in response to a user's manipulation.

Therefore, unlike in the first embodiment, the power information providing apparatus 100A cannot regard a content transmission request as an access from a user and add an access history, because the information terminal 200A sends a content transmission request even if the user is not viewing a content.

As shown in FIG. 6, the power information providing apparatus 100A acquires, from the information terminal 200A, sensor data generated by a sensor 310 that detects a behavior of the user. The sensor 310 is provided in the information terminal 200A. The sensor 310 is an infrared sensor, a vibration sensor, an illuminance sensor, a still camera, a video camera, or the like.

The information terminal 200A regularly sends values (sensor data) acquired from the sensor 310 and an ID of a content being displayed to the power information providing apparatus 100A. The sensor data is processed by an access determining module 320 of the power information providing apparatus 100A. The access determining module 320 analyzes the sensor data and determines as to whether or not the user is viewing the content. If determining that user is viewing the content, the access determining module 320 adds an access history to the access history storage 180.

For example, if the sensor 310 is an infrared sensor, the sensor data takes either of two values, that is, “an object exists in front of the information terminal 200A” and “no object exists in front of the information terminal 200A.” If an object exists in front of the information terminal 200A, the access determining module 320 determines that the user is viewing a content and adds an access history.

If the sensor 310 is a vibration sensor, the sensor data is a vibration value. If the vibration value is larger than a threshold value, the access determining module 320 determines that the user is moving near the information terminal 200A and adds an access history.

If the sensor 310 is an illuminance sensor, the sensor data is an illuminance value. If the illuminance value is smaller than a threshold value, the access determining module 320 determines that the user is standing in front of the information terminal 200A and adds an access history.

If the sensor 310 is a still camera, the sensor data is an image. The access determining module 320 analyzes a received image and adds an access history if the access determining module 320 determines that the user's eyes are directed to the information terminal 200A.

If the sensor 310 is a video camera, the sensor data is a moving image. The access determining module 320 analyzes a received moving image and adds an access history if the access determining module 320 determines that the user's eyes are directed to the information terminal 200A.

The power information providing apparatus 100A according to the second embodiment is equipped with a provided content history storage 330 that stores information indicating what contents were provided for what users at what times. More specifically, the provided content history storage 330 stores sets of 1) a user ID for identification of a user, 2) a date and time, 3) a content ID, and 4) a content type.

The power information providing apparatus 100A is also equipped with a user tendency analyzer 340. The user tendency analyzer 340 analyzes a user tendency by combining information from the provided content history storage 330, the power consumption storage 190, and the access history storage 180. For example, the user tendency analyzer 340 determines, for each user, a content (content ID) and a content type that tend to induce the user to do energy saving actions. The user tendency analyzer 340 also determines time slots in which each user views a content at a higher probability.

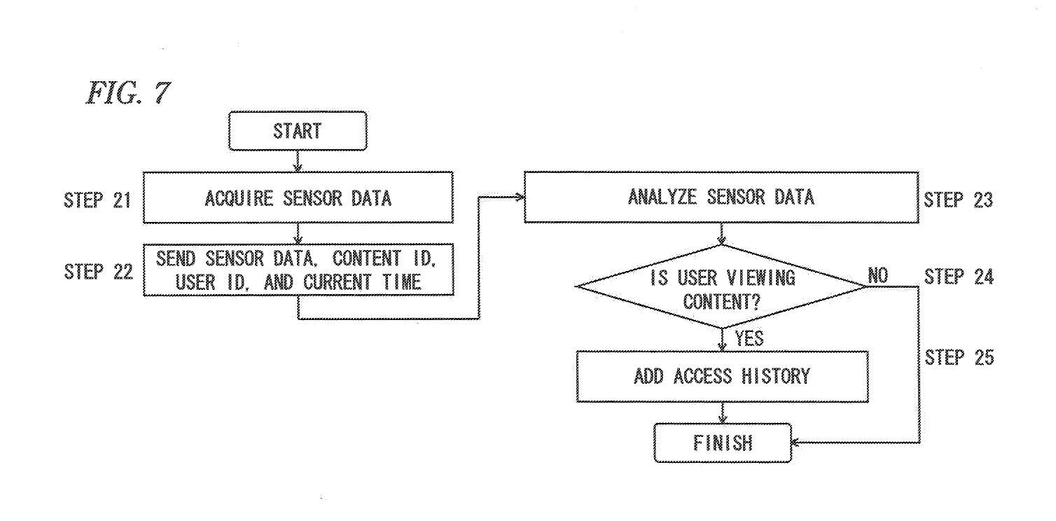

FIG. 7 is an operation flowchart showing how sensor data is acquired and analyzed,

The operation flowchart will be described below.

Step 21: The information terminal 200A acquires sensor data from the sensor 310 regularly.

Step 22: The information terminal 200A sends the sensor data, a content ID of a content being displayed, a user ID, and a current time to the power information providing apparatus 100A.

Step 23: The communication module 110 passes the sensor data, the content ID of the content being displayed, the user ID, and the current time to the access determining module 320. The access determining module 320 analyses the sensor data.

Step 24: The access determining module 320 determines as to whether or not the user is viewing the content.

Step 25: If determining that the user is viewing the content, the user tendency analyzer 340 records the user ID, the content ID, and the current time in the access history storage 180.

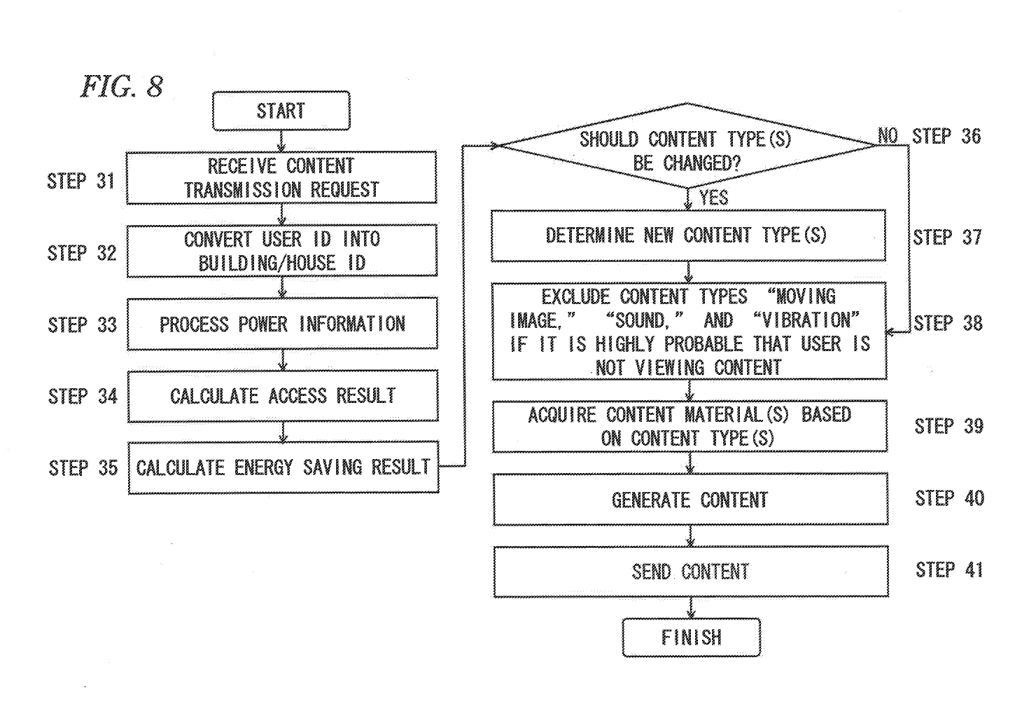

FIG. 8 is an operation flowchart showing how a content is acquired. The power information providing apparatus 100A starts to operate upon reception of a content transmission request from the information terminal 200A. The information terminal 200A sends the content transmission request in response to a user's manipulation. Or the information terminal 200A regularly sends the content transmission request for a content being displayed.

The operation flowchart will be described below.

Step 31: The communication module 110 receives a content transmission request and passes a content ID and a user ID to the content generator 120.

Step 32: The content generator 120 derives a building/house ID from the user ID.

Step 33: The content generator 120 passes the content ID and the building/house ID to the power information processor 140 and requests the power information processor 140 to return power information to be included in a content. The power information processor 140 processes power information and returns the resulting power information to the content generator 120 (the same processing as performed by the power information processor 140 of the first embodiment).

Step 34: The content generator 120 passes the user ID and the building/house ID to the content type determining module 130 and requests the content type determining module 130 to return a content type(s). The content type determining module 130 passes the user ID to the access result calculator 150 and requests the access result calculator 150 to return an access result, The access result calculator 150 calculates the access result and returns the calculated access result to the content type determining module 130 (the same processing as performed by the access result calculator 150 of the first embodiment).

Step 35: The content type determining module 130 passes the building/house ID to the energy saving result calculator 160 and requests the energy saving result calculator 160 to return an energy saving result. The energy saving result calculator 160 calculates the energy saving result and returns the calculated energy saving results to the content type determining module 130 (the same processing as performed by the energy saving result calculator 160 of the first embodiment).

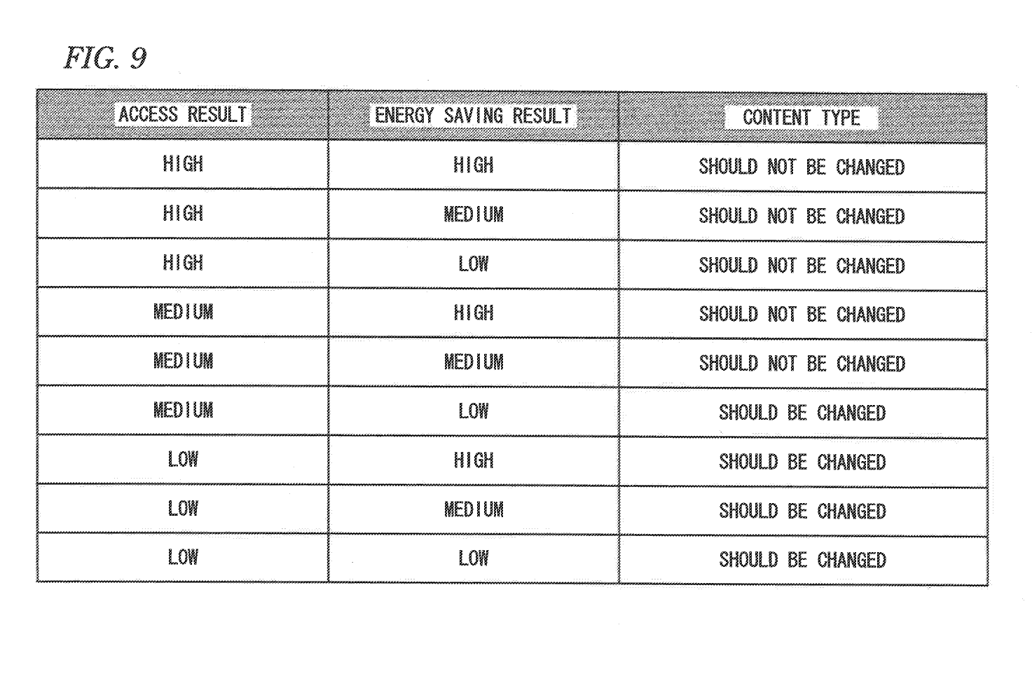

Step 36: Based on the access result of the user, the energy saving result of the user, and information stored in the provided content history storage 330, the content type determining module 130 determines as to whether or not to change the content type(s) of the content being displayed to another one (or other ones). In the second embodiment, the content type determining module 130 makes this determination using a content type determination table shown in FIG. 9. For example, the content type(s) are not changed if the access result is “high” and the energy saving results is “high.” Alternatively, the content type(s) may be changed at a prescribed probability without using the content type determination table. This makes it possible to learn how the user responds to a content type change.

Step 37: In changing the content type(s), the content type determining module 130 determines a new content type(s). The content type(s) of the content being displayed on the information terminal 200A are determined uniquely from the information supplied from the provided content history storage 330. There are various methods for changing the content type(s). The number of content type(s) may be increased to simply make the content showy. Another method is to add a content type of which no content has been provided for the user so far. A content type of which no content has been provided for the user so far can be determined from information supplied from the provided content history storage 330. A further method is to select a combination of content types that would induce energy saving actions of the user most probably. The information as to “the combination of content types that would induce the energy saving actions of the user most probably” can be acquired from the user tendency analyzer 340. The user tendency analyzer 340 can recognize “the combination of content types that would induce energy saving actions of the user most probably” using the information supplied from the provided content history storage 330 and the energy saving result in combination.

Step 38: The content type determining module 130 excludes content types “moving image,” “sound,” and “vibration” if the current time is in time slots in which it is highly probable that the user does not view the content. This makes it possible to suppress the power consumption. The information as to “the time slots in which it is highly probable that the user does not view the content” can be acquired from the user tendency analyzer 340. The user tendency analyzer 340 can recognize “the time slots in which it is highly probable that the user does not view the content” from information supplied from the access history storage 180.

Step 39: The content generator 120 acquires a content material(s) from the content material storage 170 based on the content ID and the content type(s).

Step 40: The content generator 120 generates a content based on the power information acquired from the power information processor 140 and the content material(s) acquired from the content material storage 170.

Step 41: The communication module 110 sends the information terminal 200A the content received from the content generator 120.

Operating according to the flowchart of FIG. 8, the power information providing apparatus 100A sends the content to the information terminal 200A. The information terminal 200A reproduces the received content.

Even if the information terminal 200A does not send a content transmission request to the power information providing apparatus 100A, it is possible for the power information providing apparatus 100A to provide an arbitrary content for the information terminal 200A at an arbitrary timing. For example, this can be done in such a manner that the content generator 120 generates a graph of today's power consumption and sends it to the information terminal 200A of a certain user through the communication module 110 at intervals of one hour. In this case, it is executed to remove the first step (step 31; reception of a content transmission request) in FIG. 8.

The access determining module 320 may be provided on the information terminal 200A side. In this case, the determination as to whether or not the user is viewing the content is made on the information terminal 200A side. Only when determining that the user is viewing the content, the information terminal 200A sends information to that effect to the power information providing apparatus 100A.

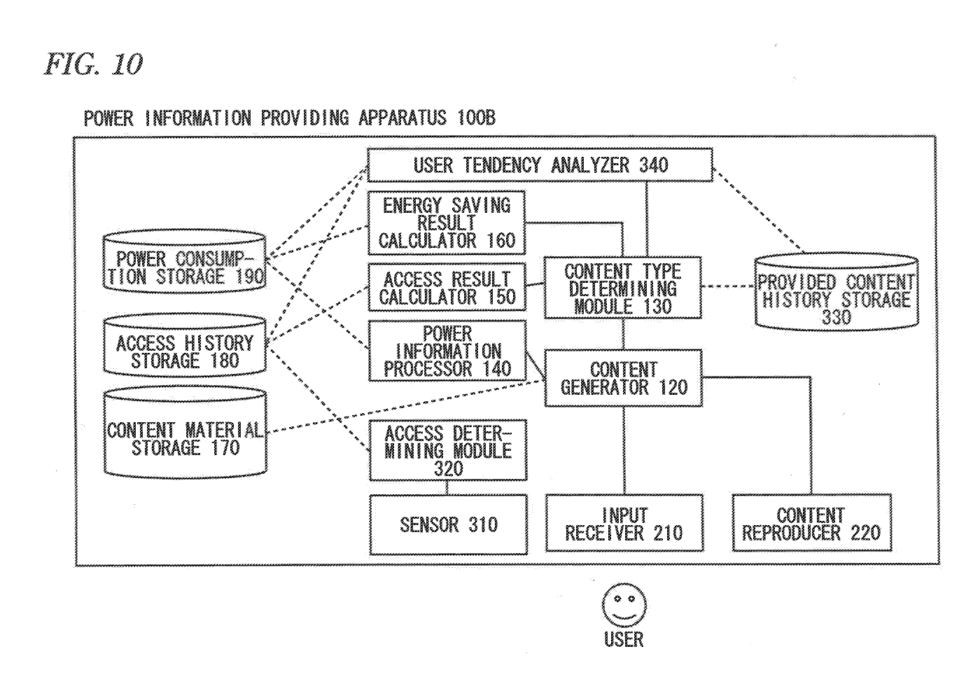

The configuration shown in FIG. 10 may be employed in which a power information providing apparatus 100B includes the functions of the information terminal. In this case, the power information providing apparatus 1008 is equipped with an input receiver 210 and a content reproducer 220. No communication modules are necessary. in response to a user's manipulation. The input receiver 210 requests the content generator to generate a content. The content generator 120 passes a generated content to the content reproducer 220.

As described above, in the power information providing apparatus 100A and 100B according to the second embodiment, the content type(s) can be changed according to an access result and a tendency of a user even in a situation where a content is always displayed on the screen. This makes it possible to prevent a user from getting tired of the visualization function, to thereby maintain its energy saving effect for a long time.

The invention is not limited to the above embodiments and, in the practice stage, may be embodied in such a manner that constituent elements are modified in various manners without departing from the spirit and scope of the invention. And, various inventive concepts may be conceived by properly combining plural constituent elements disclosed in each embodiment. For example, several ones of the constituent elements of each embodiment may be omitted. Furthermore, constituent elements of different embodiments may be combined as appropriate.

What is claimed is:

1. A power information providing apparatus that provides a content including power information, comprising:
an access result calculator configured to calculate a frequency of use of the power information providing apparatus;
an energy saving result calculator configured to calculate a value of a power consumption reduction result; and
a content type determining module configured to select a type of the content based on the frequency of use calculated by the access result calculator and the value of the power consumption reduction result calculated by the energy saving result calculator.

2. The apparatus of claim 1, further comprising:
a provided content history storage configured to store a history of contents that were provided; and
a user tendency analyzer configured to analyze data stored in the provided content history storage to obtain a tendency of energy saving of a user who is using the content; wherein
the content type determining module is configured to select the type of the content based on the tendency obtained by the user tendency analyzer as well as the frequency of use and the value of the power consumption reduction result.

3. The apparatus of claim 1, wherein the content type determining module selects the type of the content using a content type restriction table.

4. The apparatus of claim 1, further comprising:
a power information processor configured to process the power information.

5. The apparatus of claim 1, further comprising:
a content generator configured to generate the content based on the type selected by the content type determining module.

6. The apparatus of claim 1, further comprising:
an access determining module that determines as to whether or not a user is viewing a content based on data from a sensor configured to detect a behavior of the use.

7. The apparatus of claim 5, further comprising:
a communication module configured to send the content generated by the content generator to a communication terminal.

8. The apparatus of claim 5, further comprising:
an input receiver configured to receive a manipulation of a user;
a sensor configured to detect a behavior of the user and generate sensor data indicating the behavior of the user; and
a content reproducer configured to reproduce the content generated by the content generator.

9. A power information providing method by which a power information providing apparatus provides a content including power information, the method comprising:
calculating a frequency of use of the power information providing apparatus;
calculating a value of a power consumption reduction result;
selecting a type of a content according to the frequency of use and the value of the power consumption reduction result;
generating the content according to the selected type; and
providing the generated content.

10. A computer readable storage medium storing a program that causes a computer to execute a process of providing a content including power information, the process comprising:
calculating a frequency of use of the computer;
calculating a value of a power consumption reduction result;
selecting a type of the content according to the frequency of use and the value of the power consumption reduction result;
generating the content according to the selected type; and
providing the generated content.
